(19) United States
(12) Patent Application Publication
(10) Pub. No.: US 2021/0011864 A1
(43) Pub. Date: Jan. 14, 2021

(54) SYSTEM, APPARATUS AND METHODS FOR DYNAMICALLY PROVIDING COHERENT MEMORY DOMAINS

(71) Applicants: Francesc Guim Bernat, Barcelona (ES); Karthik Kumar, Chandler, AZ (US); Thomas Willhalm, Sandhausen (DE); Alexander Bachmutsky, Sunnyvale, CA (US)

(72) Inventors: Francesc Guim Bernat, Barcelona (ES); Karthik Kumar, Chandler, AZ (US); Thomas Willhalm, Sandhausen (DE); Alexander Bachmutsky, Sunnyvale, CA (US)

(21) Appl. No.: 17/032,056

(22) Filed: Sep. 25, 2020

(51) Int. Cl. G06F 13/16; G06F 13/40; G06F 12/02; G06F 11/07

(52) U.S. Cl. CPC G06F 13/1668; G06F 13/1663; G06F 13/4022; G06F 2212/154; G06F 12/0238; G06F 11/076; G06F 12/0292

(57) ABSTRACT

In one embodiment, an apparatus includes: a table to store a plurality of entries, each entry to identify a memory domain of a system and a coherency status of the memory domain; and a control circuit coupled to the table. The control circuit may be configured to receive a request to change a coherency status of a first memory domain of the system, and dynamically update a first entry of the table for the first memory domain to change the coherency status between a coherent memory domain and a non-coherent memory domain, in response to the request. Other embodiments are described and claimed.

### TECHNICAL FIELD

Embodiments relate to controlling coherency in a computing environment.

### BACKGROUND

In modern enterprise systems, memory can be implemented in a distributed manner, with different memory ranges allocated to particular devices. In such a system, one can specify statically processing entities and memory ranges that form a coherence domain. However this approach does not scale since undesirable latencies may occur as a result of coherency communications, especially when seeking to increase the number of coherent entities. And increasing coherent entity counts can cause a many-fold increase these coherency communications, which leads to bottlenecks and other performance issues.

### BRIEF DESCRIPTION OF THE DRAWINGS

FIG. 1 is a block diagram of a portion of a data center architecture in accordance with an embodiment.

FIG. 2 is a block diagram of a switch in accordance with an embodiment.

FIG. 3 is a flow diagram of a method in accordance with an embodiment.

FIG. 4 is a flow diagram of a method in accordance with another embodiment.

FIG. 5 is a block diagram of a system in accordance with another embodiment of the present invention.

FIG. 6 is a block diagram of an embodiment of a SoC design in accordance with an embodiment.

FIG. 7 is a block diagram of a system in accordance with another embodiment of the present invention.

FIG. 8 is a block diagram of a network architecture in accordance with an embodiment.

### DETAILED DESCRIPTION

In various embodiments, a system may have a memory space that is dynamically configurable to include multiple independent memory domains, each of which can be dynamically created and updated. In addition, each of these independent memory domains may be dynamically controlled to be coherent or non-coherent, and can be dynamically updated to switch coherence status. To this end, switching circuitry within the system, such as switches that couple multiple processors, devices, memory and so forth, may be configured to dynamically allocate memory ranges to given memory domains. In addition the switches may maintain and enforce coherency mechanisms when such memory domains are indicated to have a coherent status. As such, this switching circuitry may dynamically handle incoming memory requests differently depending on whether a request is directed to a coherent memory domain or a non-coherent memory domain. Furthermore, the switching circuitry may handle coherency operations differently depending upon, e.g., traffic conditions in the system. For example, a coherent memory domain may be allocated and may be associated with one or more fallback rules to provide for different coherency mechanisms to be used when high traffic conditions are present.

Although embodiments are not limited in this regard, example cloud-based edge architectures may communicate using interconnects and switches in accordance with a Compute Express Link (CXL) specification such as the CXL 1.1 Specification or any future versions, modifications, variations or alternatives to a CXL specification. Further, while an example embodiment described herein is in connection with CXL-based technology, embodiments may be used in other coherent interconnect technologies such as an IBM XBus protocol, an Nvidia NVLink protocol, an AMD Infinity Fabric protocol, cache coherent interconnect for accelerators (CCIX) protocol or coherent accelerator processor interface (OpenCAPI).

Many systems provide a single coherent memory domain such that all compute devices (e.g., multiple processor sockets) and add-on devices (such as accelerators or so forth) are in the same coherent domain. Such configuration may be beneficial to enable shared computing and shared memory across the processors. However, increasing the number of coherent agents also increases the amount of coherence traffic. As an example, adding four processor sockets to a system to take it from a 4-socket system to an 8-socket system can increase coherence traffic by a 3× amount, which can undesirably affect latency, and greater numbers of sockets increases this traffic even further. This is especially so when also considering add-on devices and accelerators, which may be part of this single coherent memory domain.

As such, embodiments can dynamically and at a fine-grained level control coherency of memory. In embodiments, a shared coherence domain-based protocol may communicate over CXL interconnects in a manner that is flexible and scalable. As a result, via a CXL switch, multiple servers or racks can converse in memory semantics with CXL.cache or CXL.mem semantics. With an embodiment, applications can implement coherency dynamically and independently using CXL.cache semantics.

When a memory device attached via a CXL link has coherency disabled, the memory device can be made local-only without coherence. As an example, an add-on accelerator with add-on memory or an add-on memory expansion card can be: (1) configured in “device bias” mode and not coherent with any other entity and used only exclusively by the device; or (2) configured in “host-bias” mode and made globally coherent with the rest of the platform.

In cloud server implementations such as a multi-tenant data center, a system may have multiple coherency domains, such as per tenant coherency. As an example, each of multiple (potentially a large number of different tenants) may be associated with a memory domain (or multiple memory domains). Note that these separate memory domains may be isolated from each other such that a first tenant allocated to a first memory domain cannot access a second memory domain allocated to a second tenant (and vice versa). In other cases, there may be more flexible relationships between tenants and memory domains. In embodiments, coherent domains are managed on a per tenant basis.

One example implementation may be in connection with a database server or database management system configured to run on a cloud-based architecture. In such a system there may be multiple nodes implemented, where at least some of the nodes have a segment called a main store that does not require coherence since it is read-only. This main store may consume a large percentage (e.g., 50%) of the total memory capacity used by the database. While other sections of the database may require coherence for particular transactions, embodiments can provide a fine-grained, flexible mechanism within the application to define coherence requirements. This dynamic and flexible approach provided in embodiments thus differs from a static, upfront, hard-partitioning at a node level or memory region level.

To realize this arrangement, embodiments provide mechanisms to expose to an application or other requester the ability to dynamically configure and update coherency status, among other aspects of a memory domain. For example, when allocating a memory region like the main store that does not require coherence, an application can specify a memory allocation request as follows: cxl-mmap([A,B], allocate, 800 GB, NULL <coherence>, NULL <call-back>). With this example memory allocation request, a requester provides information regarding a memory range request type (allocate request), an amount of space requested, and indicators for a coherency status and call-back information (neither of which is active in this particular request).

However, while allocating a memory region that will be used for a transaction, the application can specify coherence and further define entities that are permitted access to this coherent memory domain (e.g., in terms of process address space identifiers (PASIDs), e.g., PASID2, PASID3, and PASID5). This is shown in the following memory allocation request: cxl-mmap([C,D], allocate, 100 GB, PASID2,PASID3,PASID5, NULL <call-back>). Note that in addition, memory domains may be associated with a tenant ID that in turn can be mapped into one or more PASIDs, to provide per-tenant coherency. Note that in some implementations, a “tenant” may be defined as one instance of all processes. Embodiments may enable definition of a coherent domain as one of two options: (1) ID (tenant ID), which includes a set of PASIDs; and (2) PASID granularity (which can be identified by tenant ID and PASID).

Now one can also turn off coherence after a transaction is completed, by using the same memory allocation request, using a modify indicator rather than an allocate indicator as follows: cxl-mmap([C,D], modify, 100 GB, NULL <coherence>, NULL <call-back>). The same mechanism can be used to turn on coherence later, for example, to update coherence only for PASID5, as follows: cxl-mmap([C,D], modify, 100 GB, PASID5, NULL <call-back>).

As further shown above, these memory allocation and update requests may include an extension termed a “call-back,” which can be used to specify CXL-based call-back rules. These rules may provide for fallback operations for handling coherency if one or more links are saturated. This is analogous to back-off mechanisms for locking, for example, where if a lock is not acquired, another code path or option is taken. As one example, a call-back option may call for using a software multi-phase commit protocol to implement coherence if a switch generates a call-back signal indicating that the interconnects are saturated due to coherence operations: cxl-mmap([C,D], modify, 100 GB, PASID5, CALL-BACK CODEPATH *swcommitprotocol(C,D,PASID5)).

Another option for the call-back could be quality of service, where if the interconnects are saturated, a given PASID (e.g., PASID 2) receives high priority/dedicated switch credits (e.g., PASID 2 is performing the primary coherence-requiring operation, whereas PASID 3 and PASID5 are just collecting statistical analytics or doing garbage collection) as follows: cxl-mmap([C,D], modify, 100 GB, PASID5, CALL-BACK QOS PASID 2).

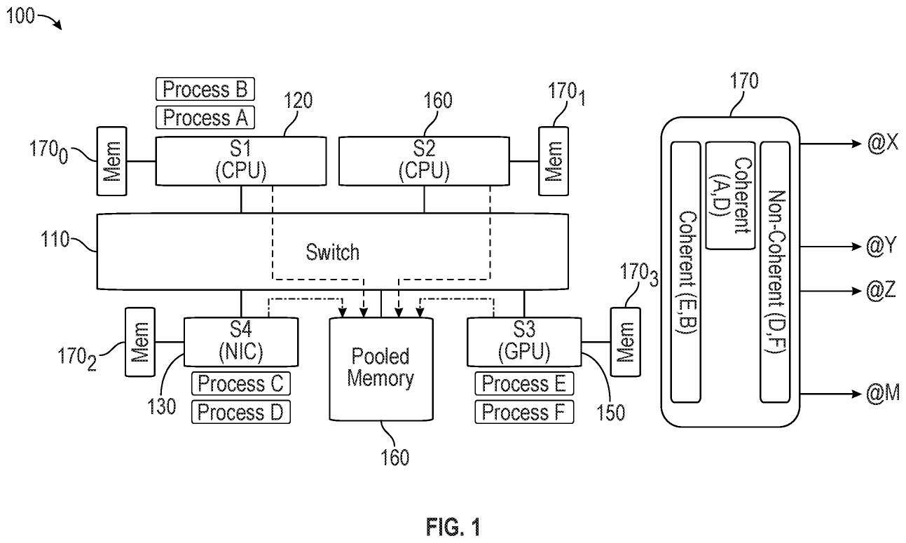

Referring now to FIG. 1, shown is a block diagram of a portion of a data center architecture in accordance with an embodiment. As shown in FIG. 1, system 100 may be a collection of components implemented as one or more servers of a data center. As illustrated, system 100 includes a switch 110, e.g., a CXL switch in accordance with an embodiment. In other implementations, switch 110 may be another type of coherent switch. Note however that in any event, switch 110 is implemented as a coherent switch and not an ethernet type of switch. By way of switch 110, which acts as a fabric, various components including one or more central processing units (CPUs) 120, 160, one or more special function units such as a graphics processing unit (GPU) 150, and a network interface circuit (NIC) 130 may communicate with each other. More specifically, these devices, each of which may be implemented as one or more integrated circuits, provide for execution of functions that communicate with other functions in other devices via one of multiple CXL communication protocols. For example, CPU 120 may communicate with NIC 130 via a CXL.io communication protocol. In turn, CPUs 120,160 may communicate with GPU 150 via a CXL.mem communication protocol. And, CPUs 120, 160 may communicate with each other and from CPU 160 to GPU 150 via a CXL.cache communication protocol, as examples. Switch 110 may include control circuitry that allows different memory domains to be dynamically allocated and updated (including coherency status) for devices and applications or services. For instance, different processes may request coherency across certain memory ranges while other processes may not need coherency at all.

As further shown in FIG. 1, a system memory may be formed of various memory devices. In the embodiment shown, a pooled memory 160 is coupled to switch 110. Various components may access pooled memory 160 via switch 110. In addition, multiple portions of the system memory may couple directly to particular components. As illustrated, memory devices 170₀₋₃ are distributed such that various regions directly couple to corresponding CPUs 120, 160, NIC 130, and GPU 150.

As further illustrated in FIG. 1, in response to memory allocation requests issued by processes, various coherent and non-coherent memory domains may be maintained within memory 170. Understand while shown at this high level in the embodiment of FIG. 1, many variations and alternatives are possible.

Via an interface in accordance with an embodiment, software (e.g., a system stack) enables specification dynamically of these types of memory domains. In an embodiment, a memory domain is composed by a set of memory regions with address ranges, list of PASIDs associated with the memory domain and the type of coherency (e.g., coherent, non-coherent, read only etc.). Memory domains at the device level (e.g., GPU and CPU) can be defined as well. In other cases, a memory domain can be mapped into a single address range, where a tenant may have multiple memory domains.

Circuitry within a switch may implement the aforementioned coherency domains. To this end, the circuitry may be configured to intercept snoops and other CXL.cache flows and determine whether they need to cross the switch or not. In a negative case, it returns a corresponding CXL.cache response to inform the snoop requestor that the address is not hosted in the target platform or device for that request.

Note that dynamic coherent memory domains as described herein may be implemented without any modification on any coherency agent (such as a caching agent (CA) in the CPU).

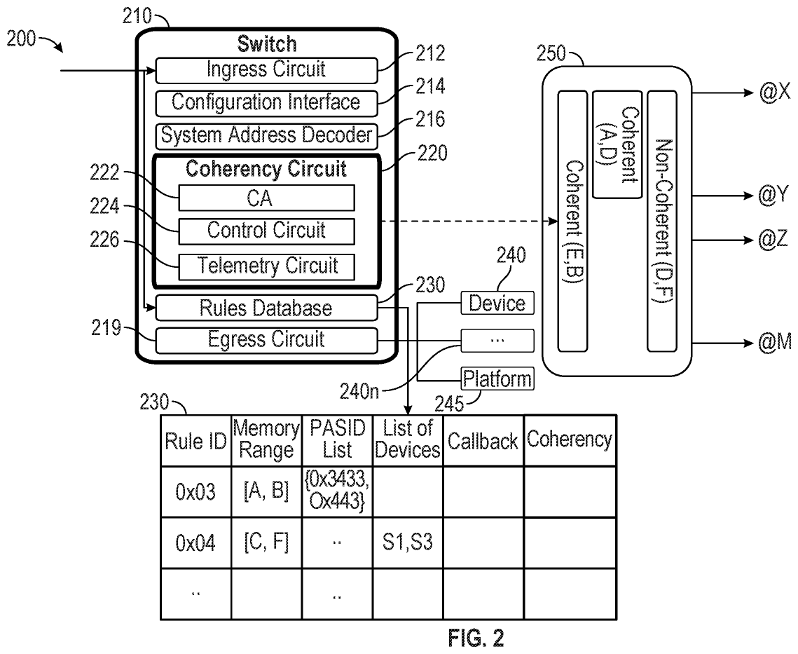

Referring now to FIG. 2 shown is a block diagram of a switch in accordance with an embodiment. As shown in FIG. 2, switch 200 includes various circuitry including an ingress circuit 212, via which incoming requests are received, and an egress circuit 219, via which outgoing communications are sent. For purposes of describing the dynamic coherency mechanisms herein, switch 210 further includes a configuration interface 214 which may expose to applications the capabilities herein, including the ability to dynamically instantiate and update coherent memory domains. To determine whether an incoming request is for a coherent domain, a coherency circuit 220 may leverage information in a system address decoder 218, which may decode incoming system addresses in requests.

As further shown in the inset in FIG. 2, coherency circuit 220 includes a caching agent (CA) circuit 222, which may perform snoop processing and other coherency processing. More specifically, when a control circuit 224 determines that a request is to be coherently processed, it may enroll CA circuit 222 to perform coherency processing. This determination may be based at least in part on information maintained by a telemetry circuit 226, which may track traffic through the system, including interconnect bandwidth levels.

As further shown in FIG. 2, a rules database 230 is provided within switch 210, which may store information regarding different memory domains. As shown, rules database 230 includes multiple entries, each associated with a given memory domain. As illustrated, each entry includes a plurality of fields, including a rule ID field, a memory range field, a PASID list field, a device list field, a call-back field, and a coherency status field. These different fields may be populated in response to a memory allocation request, and may further be updated in response to additional requests for updates so forth.

Embodiments may be applicable to multi-tenant usages in cloud and edge computing, and cloud native applications with many microservices that do not have global coherence. For further illustration purposes, multiple independent CXL-coherence domains associated with different tenants can be isolated in a system memory. For example, one could have an application deploying containers or virtual machines that specify the following domains:

Domain 1—VMs A, B, C=compute devices S1,S2,S3,A3 sharing memory range [x,y]

Domain 2—VMs D, E=compute devices S3, S4, S5, A4 sharing memory range [z,t]

Domain 3—shared memory between VMs C and D—all compute devices

App A generates snoop @X1 [x,y], the CXL switch only snoops S1,S2,S3, A3.

As shown in FIG. 2, these different memory domains that are shared across the platforms are not coherent across all compute devices. For each memory range, a set of targets to snoop are specified, such as shown with Domains 1, 2, and 3 above. Further, some regions of memory may be read-only, like a main store of a database, which may account for a large percentage of memory capacity usage. There is no need to snoop or have coherence for such defined regions.

With this arrangement, switch 210 may provide coherency quality of service (QoS) between coherent domains and within coherent domains. In this way, switch 210 exposes interfaces that can be used by: (1) the infrastructure owner to specify what coherent QoS (in terms of priority or coherent transactions per second) are associated to each coherent domain; and (2) the coherent domain owner to specify what is the level of QoS associated between coherency flows between each of the participants of a domain.

Via telemetry circuit 226, active telemetry coherency saturation awareness is realized. This allows software stacks to be aware how access to different objects within a coherent domain may experience performance degradation. In an embodiment, telemetry circuit 226 may track the saturation of the various paths between each of the participants of the domain and the various objects and notify each of them depending on provided monitoring rules.

In an embodiment for implementing monitoring and quality of services flows, switch 210 can include content addressable memory (CAM)-based types of structures that can be tagged by object ID in order to track the access and apply QoS enforcement. To this end, system address decoder 216 tracks the different objects and maps a coherency request (such as a read request) to that object. Hence, on a particular coherency request, switch 210 may use SAD 216 to discover to what coherent domain and object it belongs; identify the QoS achieved and specified and determine when to process the request. Note that if it is determined to not yet process the request, then it can be stored in a queue. When a request is processed. it may proceed if the domain is coherent. If it is not coherent, switch 210 may execute a “fake” flow and respond to the originator with a response expected when a target does not have the line. Further, switch 210 directly sends the request to the target via egress circuit 219. As one example, when faking the flow the switch may return a global observation signal (e.g., ACK GO) (indicating to the originator that no one has that line).

Switch 210, via configuration interface 214, may provide for registering a new coherent domain. In an embodiment, this interface allows specifying identifying of the address domain; and memory range that belongs to that memory domain. Here the assumption is that the physical memory range (from 0 . . . N) is mapped to all the different addressable memories in the system; the interface also enables specification of elements within the memory domain, a list of process address ID (PASID) that belong to the memory domain, and optionally the list of devices within the memory domain. Configuration interface 214 further may enable changing or removing a memory domain.

Coherency circuit 220 may be configured to intercept CXL.cache requests and determine whether to intercept them or not. To this end, control circuit 224 may, for a request, use system address decoder 218 to identify if there is any coherency domain mapped into a particular address space that matches the memory address in the request. If no coherent domain is found, the request exits egress circuit 219 towards the final target.

If one or multiple domains are found, per each of them coherency circuit 220 may: check if the PASID included in the request maps into that domain. If so, the request exits egress circuit 219 towards the final target. If not, coherency circuit 220 may drop the snoop or memory CXL.cache request. Coherency circuit 220 implements the coherency response corresponding to that particular CXL.cache request. For instance, respond invalid.

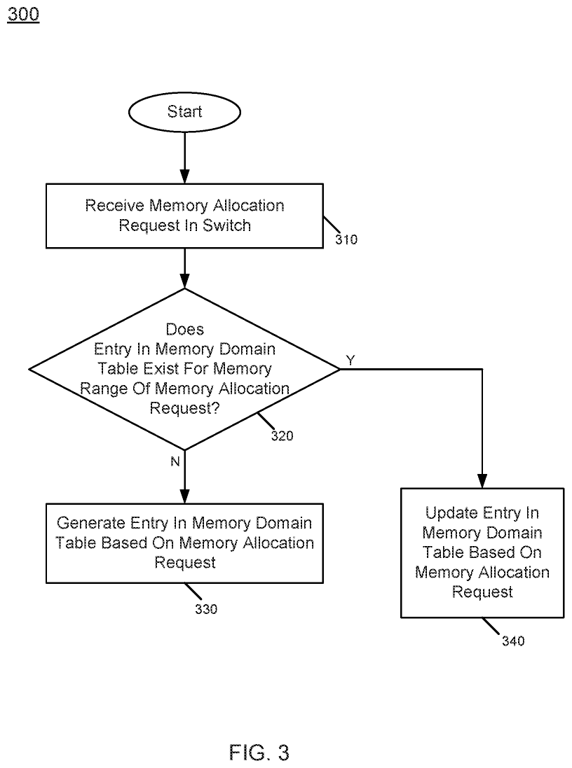

Referring now to FIG. 3, shown is a flow diagram of a method in accordance with an embodiment. As shown in FIG. 3, method 300 is a method for generating and updating memory properties in response to a memory allocation request. As such, method 300 may be performed by switch circuitry, such as a coherency circuit within a switch in accordance with an embodiment. As such, method 300 may be performed by hardware circuitry, firmware, software, and/or combinations thereof.

As illustrated, method 300 begins by receiving a memory allocation request in a switch (block 310). As an example, an application such as a VM, process or any other software entity may issue this request, which may include various information. Although embodiments are not limited in this regard, example information in the request may include memory range information, coherency status, address space identifier information and so forth.

Next control passes to diamond 320 where it is determined whether an entry already exists in a memory domain table for a memory range of this memory allocation request. If not, control passes to block 330 where an entry in this table may be generated. As one example, the entry may include the fields described above with regard to FIG. 2. Otherwise if it is determined that an entry already exists, control passes to block 340 where the entry may be updated. For example, a coherency status may be changed, e.g., making a coherent domain a non-coherent domain, such as after a transaction completes, deleting a memory domain such as when application terminates or so forth. While shown at this high level in the embodiment of FIG. 3, many variations and alternatives are possible.

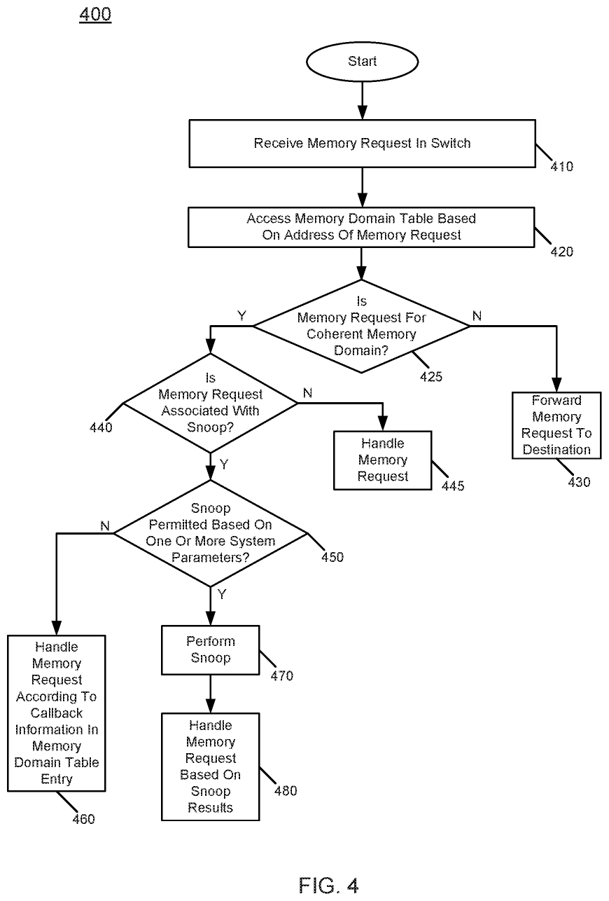

Referring now to FIG. 4, shown is a flow diagram of a method in accordance with another embodiment. As shown in FIG. 4, method 400 is a method for handling an incoming memory request in a switch. As such, method 400 may be performed by various circuitry within the switch. As such, method 400 may be performed by hardware circuitry, firmware, software, and/or combinations thereof.

Method 400 begins by receiving a memory request in the switch (block 410). Assume for purposes of discussion that this memory request is for reading data. This read request includes an address at which requested data is located. Next at block 420 a memory domain table may be accessed based on an address of the memory request, e.g., to identify an entry in the table associated with a memory domain including the address.

At diamond 425 it is determined whether this memory request is for a coherent memory domain. This determination may be based on a coherency status indicator present in a coherency status field of the relevant entry of the memory domain table. If not, control passes to block 430 where the memory request is forwarded to the destination location without further processing within the switch, since this request is directed to a non-coherent domain.

Still with reference to FIG. 4 if it is determined that the request is for a coherent memory domain, control passes to diamond 440 to determine whether the memory request is associated with a snoop. This determination may be based on whether this request is for a read, in which case snoop processing may be performed. Other memory requests, such as a write request, may be directly handled without snoop processing (block 445).

Control next passes to diamond 450 to determine whether snoop processing is permitted. This determination may be based on one or more system parameters, such as interconnect status. If it is determined that snoop processing is not permitted, such as where high interconnect traffic is present, control passes to block 460. At block 460, the memory request may be handled according to call-back information. More specifically, the relevant entry in the memory domain table may be accessed to determine a fallback processing mechanism that may be used for handling snoop processing. In this way, reduced interconnect traffic may be realized.

Still with reference to FIG. 4, if it is determined that snoop processing is permitted at diamond 450, control passes to block 470 where snoop processing is performed to determine the presence and status of requested data in various distributed caches and other memory structures. Next at block 480, the memory request may be handled based on snoop results. For example, when it is determined that a most recent copy of the data is valid, the read request may be performed. Or on an indication of dirty data, dirty data may be used to provide a read completion. While shown at this high level in the embodiment of FIG. 4, many variations and alternatives are possible.

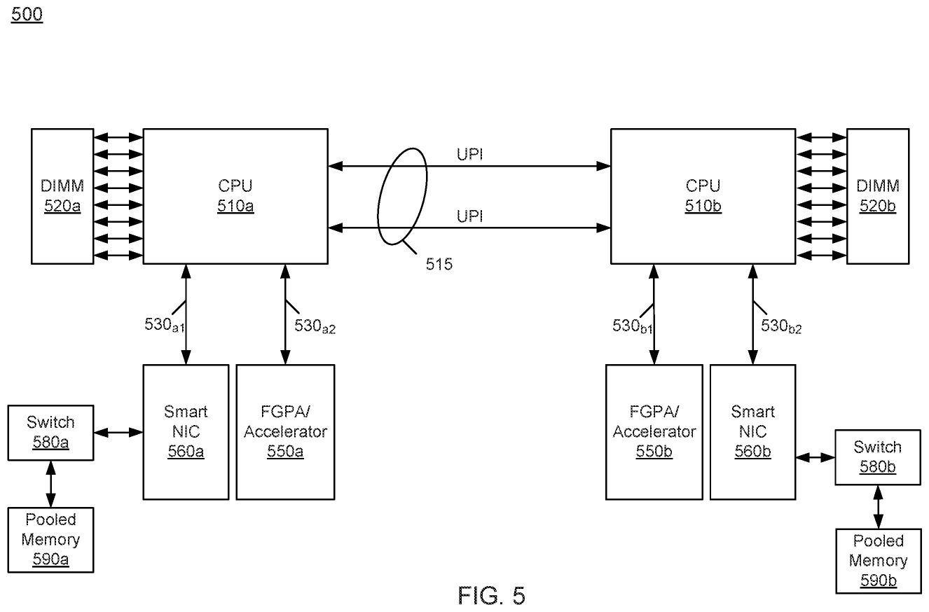

Referring now to FIG. 5, shown is a block diagram of a system in accordance with another embodiment of the present invention. As shown in FIG. 5, a system 500 may be any type of computing device, and in one embodiment may be a server system such as an edge platform. In the embodiment of FIG. 5, system 500 includes multiple CPUs 510a,b that in turn couple to respective system memories 520a,b which in embodiments may be implemented as dual inline memory modules (DIMMs) such as double data rate (DDR) memory, persistent or other types of memory. Note that CPUs 510 may couple together via an interconnect system 515 such as an Intel® Ultra Path Interconnect or other processor interconnect technology.

To enable coherent accelerator devices and/or smart adapter devices to couple to CPUs 510 by way of potentially multiple communication protocols, a plurality of interconnects 530a1-b2 may be present. In an embodiment, each interconnect 530 may be a given instance of a CXL.

In the embodiment shown, respective CPUs 510 couple to corresponding field programmable gate arrays (FPGAs)/accelerator devices 550a,b (which may include graphics processing units (GPUs), in one embodiment. In addition CPUs 510 also couple to smart NIC devices 560a,b. In turn, smart NIC devices 560a,b couple to switches 580a,b (e.g., CXL switches in accordance with an embodiment) that in turn couple to a pooled memory 590a,b such as a persistent memory. In embodiments, switches 580 may perform fine-grained and dynamic coherency management of independent coherent (and non-coherent) memory domains, as described herein. Of course, embodiments are not limited to switches and the techniques described herein may be performed by other entities of a system.

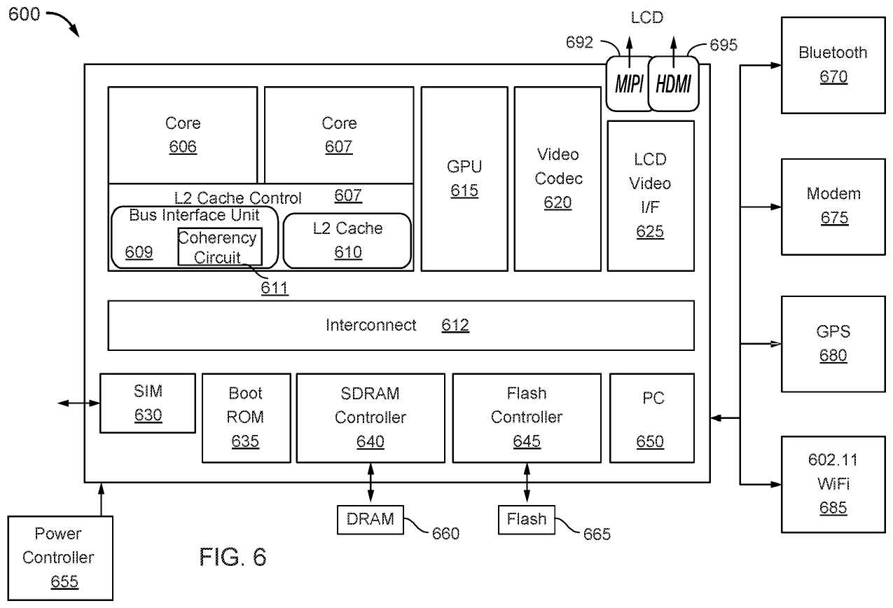

Turning next to FIG. 6, an embodiment of a SoC design in accordance with an embodiment is depicted. As a specific illustrative example, SoC 600 may be configured for insertion in any type of computing device, ranging from portable device to server system. Here, SoC 600 includes 2 cores 606 and 607. Cores 606 and 607 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 606 and 607 are coupled to cache controller 608 that is associated with bus interface unit 609 and L2 cache 610 to communicate with other parts of system 600 via an interconnect 612. As seen, bus interface unit 609 includes a coherency circuit 611, which may perform coherency operations as described herein.

Interconnect 612 provides communication channels to the other components, such as a Subscriber Identity Module (SIM) 630 to interface with a SIM card, a boot ROM 635 to hold boot code for execution by cores 606 and 607 to initialize and boot SoC 600, a SDRAM controller 640 to interface with external memory (e.g., DRAM 660), a flash controller 645 to interface with non-volatile memory (e.g., flash 665), a peripheral controller 650 (e.g., an eSPI interface) to interface with peripherals, video codec 620 and video interface 625 to display and receive input (e.g., touch enabled input), GPU 615 to perform graphics related computations, etc. In addition, the system illustrates peripherals for communication, such as a Bluetooth module 670, 3G modem 675, GPS 680, and WiFi 685. Also included in the system is a power controller 655. Further illustrated in FIG. 6, system 600 may additionally include interfaces including a MIPI interface 692, e.g., to a display and/or an HDMI interface 695 also which may couple to the same or a different display.

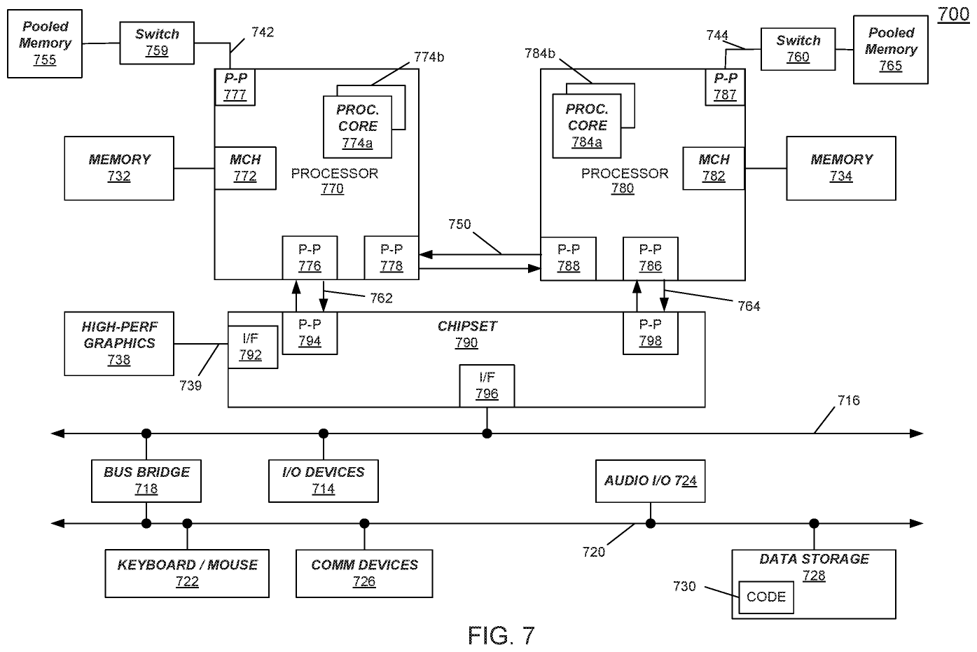

Referring now to FIG. 7, shown is a block diagram of a system in accordance with another embodiment of the present invention such as an edge platform. As shown in FIG. 7, multiprocessor system 700 includes a first processor 770 and a second processor 780 coupled via a point-to-point interconnect 750. As shown in FIG. 7, each of processors 770 and 780 may be many core processors including representative first and second processor cores (i.e., processor cores 774a and 774b and processor cores 784a and 784b).

In the embodiment of FIG. 7, processors 770 and 780 further include point-to point interconnects 777 and 787, which couple via interconnects 742 and 744 (which may be CXL buses) to switches 759 and 760, which may perform fine-grained and dynamic coherency management of independent coherent (and non-coherent) memory domains as described herein. In turn, switches 759, 760 couple to pooled memories 755 and 765. In this way, switches 759, 760 may, based on rules provided by, e.g., application executing on processors 770 and 780, perform traffic monitoring and dynamic control of coherency traffic, including re-configuring to a fallback mechanism for certain coherency traffic based on interconnect congestion levels that exceed a given threshold, as described herein.

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of system memory (e.g., DRAM) locally attached to the respective processors. First processor 770 and second processor 780 may be coupled to a chipset 790 via P-P interconnects 776 and 786, respectively. As shown in FIG. 7, chipset 790 includes P-P interfaces 794 and 798.

Furthermore, chipset 790 includes an interface 792 to couple chipset 790 with a high performance graphics engine 738, by a P-P interconnect 739. As shown in FIG. 7, various input/output (I/O) devices 714 may be coupled to first bus 716, along with a bus bridge 718 which couples first bus 716 to a second bus 720. Various devices may be coupled to second bus 720 including, for example, a keyboard/mouse 722, communication devices 726 and a data storage unit 728 such as a disk drive or other mass storage device which may include code 730, in one embodiment. Further, an audio I/O 524 may be coupled to second bus 720.

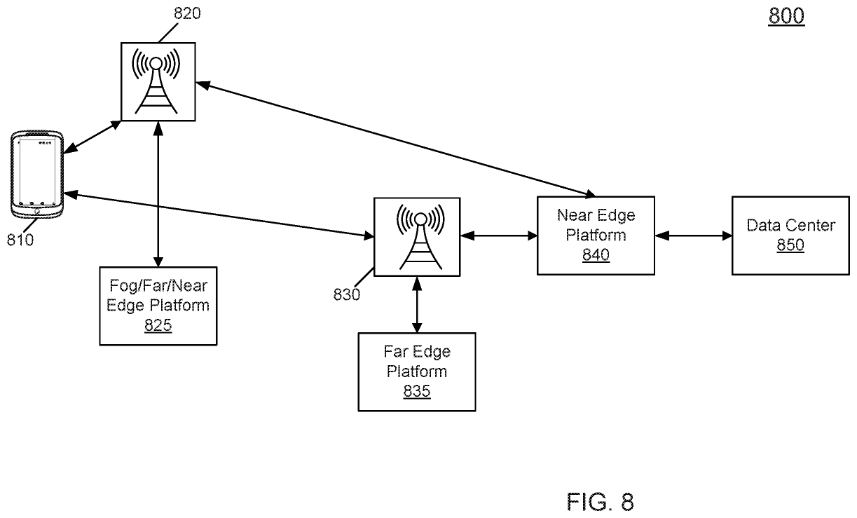

Embodiments as described herein can be used in a wide variety of network architectures. To this end, many different types of computing platforms in a networked architecture that couples between a given edge device and a datacenter can perform the fine-grained and dynamic coherency management of independent coherent (and non-coherent) memory domains described herein. Referring now to FIG. 8, shown is a block diagram of a network architecture in accordance with another embodiment of the present invention. As shown in FIG. 8, network architecture 800 includes various computing platforms that may be located in a very wide area, and which have different latencies in communicating with different devices.

In the high level view of FIG. 8, network architecture 800 includes a representative device 810, such as a smartphone. This device may communicate via different radio access networks (RANs), including a RAN 820 and a RAN 830. RAN 820 in turn may couple to a platform 825, which may be an edge platform such as a fog/far/near edge platform, and which may leverage embodiments herein. Other requests may be handled by a far edge platform 835 coupled to RAN 830, which also may leverage embodiments.

As further illustrated in FIG. 8, another near edge platform 840 may couple to RANs 820, 830. Note that this near edge platform may be located closer to a data center 850, which may have a large amount of computing resources. By pushing messages to these more remote platforms, greater latency is incurred in handling requests on behalf of edge device 810. Understand that all platforms shown in FIG. 8 may incorporate embodiments as described herein to perform fine-grained and dynamic coherency management of independent coherent (and non-coherent) memory domains.

The following examples pertain to further embodiments.

In one example, an apparatus comprises: a table to store a plurality of entries, each entry to identify a memory domain of a system and a coherency status of the memory domain; and a control circuit coupled to the table. The control circuit may receive a request to change a coherency status of a first memory domain of the system, and may dynamically update a first entry of the table for the first memory domain to change the coherency status between a coherent memory domain and a non-coherent memory domain.

In an example, the control circuit is to receive a memory allocation request for a second memory domain of the system and write a second entry in the table for the second memory domain, the second entry to indicate a coherency status of the second memory domain as one of the coherent memory domain or the non-coherent memory domain.

In an example, the first entry comprises memory region information, one or more process address identifiers that belong to the first memory domain, one or more attributes regarding the first memory domain, and call-back information.

In an example, the call-back information comprises at least one fallback rule for handling coherency for a memory request when an interconnect congestion level exceeds a threshold.

In an example, the apparatus further comprises a telemetry circuit to maintain telemetry information comprising the interconnect congestion level.

In an example, the apparatus is to handle coherency for memory requests according to at least one fallback rule when an interconnect congestion level exceeds a threshold.

In an example, the apparatus comprises a coherent switch to receive, prior to the coherency status change request, a first memory request for a first location in the first memory domain and perform coherency processing and, after the coherency status change request, receive a second memory request for another location in the first memory domain and direct the second memory request to a destination of the second memory request without performing the coherency processing.

In an example, the control circuit is to receive a memory allocation request for a second memory domain of the system comprising a main data store of a database application, the memory allocation request to indicate a coherency status of the second memory domain as a non-coherent memory domain, and in response to the memory allocation request, the control circuit is to write a second entry in the table for the second memory domain, the second entry to indicate the coherency status of the second memory domain as the non-coherent memory domain.

In another example, a method comprises: receiving, in a switch of a system, a memory request, the switch coupled between a requester and a target memory; determining whether an address of the memory request is within a coherent memory domain; if the address of the memory request is within the coherent memory domain, performing snoop processing for the memory request and handling the memory request based on the snoop processing; and if the address of the memory request is not within the coherent memory domain, directing the memory request from the switch to the target memory without performing the snoop processing.

In an example, the method further comprises determining an interconnect congestion level.

In an example, the method further comprises if the interconnect congestion level is greater than a threshold, handling the memory request according to call-back information associated with the coherent memory domain, the call-back information stored in a memory domain table.

In an example, the method further comprises determining whether the address is within the coherent memory domain based on memory range information stored in a memory domain table.

In an example, the method further comprises receiving a memory allocation request for a first coherent memory domain and storing an entry for the first coherent memory domain in a memory domain table, the entry including memory region information, one or more process address identifiers that belong to the first coherent memory domain, one or more devices within the first coherent memory domain, and call-back information to identify at least one fallback rule for handling a memory request to the first coherent memory domain when an interconnect congestion level exceeds a threshold.

In an example, the method further comprises: allocating a first memory domain for a first tenant in response to a first memory allocation request for a coherent memory domain associated with a first plurality of devices of the system and a first memory range; and allocating a second memory domain for a second tenant in response to a second memory allocation request for a non-coherent memory domain associated with a second plurality of devices of the system and a second memory range, where the first memory domain is isolated from the second memory domain.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises: a plurality of processors; a plurality of accelerators; a system memory to be dynamically partitioned into a plurality of memory domains including at least one coherent memory domain and at least one non-coherent memory domain; and a switch to couple at least some of the plurality of processors and at least some of the plurality of accelerators via Compute Express Link (CXL) interconnects. The switch may dynamically create the at least one coherent memory domain in response to a first memory allocation request and dynamically create the at least one non-coherent memory domain in response to a second memory allocation request.

In an example, the switch is to dynamically update the at least one coherent memory domain to be another non-coherent memory domain in response to a memory update request.

In an example, the switch comprises a CXL switch comprising a memory domain table having a plurality of entries, each of the plurality of entries to store memory region information, at least one of one or more process address identifiers or at least one of one or more tenant identifiers that belong to a memory domain, and one or more devices within the memory domain.

In an example, at least some of the plurality of entries are to further store least one fallback rule for handling a memory request when an interconnect congestion level exceeds a threshold.

In an example, the CXL switch further comprises a telemetry circuit to maintain telemetry information comprising the interconnect congestion level.

In an example, the CXL switch is to receive the first memory allocation request comprising a memory range for the at least one coherent memory domain, a coherency indicator, one or more process address identifiers that belong to the at least one coherent memory domain, one or more devices within the at least one coherent memory domain, and at least one fallback rule for handling coherency for a memory request when a congestion level on one or more of the CXL interconnects exceeds a threshold.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a table to store a plurality of entries, each entry to identify a memory domain of a system and a coherency status of the memory domain; and
a control circuit coupled to the table, the control circuit to receive a request to change a coherency status of a first memory domain of the system, wherein the control circuit is to dynamically update a first entry of the table for the first memory domain to change the coherency status between a coherent memory domain and a non-coherent memory domain.

2. The apparatus of claim 1, wherein the control circuit is to receive a memory allocation request for a second memory domain of the system and write a second entry in the table for the second memory domain, the second entry to indicate a coherency status of the second memory domain as one of the coherent memory domain or the non-coherent memory domain.

3. The apparatus of claim 1, wherein the first entry comprises memory region information, one or more process address identifiers that belong to the first memory domain, one or more attributes regarding the first memory domain, and call-back information.

4. The apparatus of claim 3, wherein the call-back information comprises at least one fallback rule for handling coherency for a memory request when an interconnect congestion level exceeds a threshold.

5. The apparatus of claim 4, further comprising a telemetry circuit to maintain telemetry information comprising the interconnect congestion level.

6. The apparatus of claim 1, wherein the apparatus is to handle coherency for memory requests according to at least one fallback rule when an interconnect congestion level exceeds a threshold.

7. The apparatus of claim 1, wherein the apparatus comprises a coherent switch, the coherent switch to receive, prior to the coherency status change request, a first memory request for a first location in the first memory domain and perform coherency processing and, after the coherency status change request, receive a second memory request for another location in the first memory domain and direct the second memory request to a destination of the second memory request without performing the coherency processing.

8. The apparatus of claim 1, wherein the control circuit is to receive a memory allocation request for a second memory domain of the system comprising a main data store of a database application, the memory allocation request to indicate a coherency status of the second memory domain as a non-coherent memory domain, and in response to the memory allocation request, the control circuit is to write a second entry in the table for the second memory domain, the second entry to indicate the coherency status of the second memory domain as the non-coherent memory domain.

9. At least one computer readable storage medium having stored thereon instructions, which if performed by a machine cause the machine to perform a method comprising:
receiving, in a switch of a system, a memory request, the switch coupled between a requester and a target memory;
determining whether an address of the memory request is within a coherent memory domain;
if the address of the memory request is within the coherent memory domain, performing snoop processing for the memory request and handling the memory request based on the snoop processing; and
if the address of the memory request is not within the coherent memory domain, directing the memory request from the switch to the target memory without performing the snoop processing.

10. The at least one computer readable storage medium of claim 9, wherein the method further comprises determining an interconnect congestion level.

11. The at least one computer readable storage medium of claim 10, wherein the method further comprises if the interconnect congestion level is greater than a threshold, handling the memory request according to call-back information associated with the coherent memory domain, the call-back information stored in a memory domain table.

12. The at least one computer readable storage medium of claim 9, wherein the method further comprises determining whether the address is within the coherent memory domain based on memory range information stored in a memory domain table.

13. The at least one computer readable storage medium of claim 9, wherein the method further comprises receiving a memory allocation request for a first coherent memory domain and storing an entry for the first coherent memory domain in a memory domain table, the entry including memory region information, one or more process address identifiers that belong to the first coherent memory domain, one or more devices within the first coherent memory domain, and call-back information to identify at least one fallback rule for handling a memory request to the first coherent memory domain when an interconnect congestion level exceeds a threshold.

14. The at least one computer readable storage medium of claim 9, wherein the method further comprises:
allocating a first memory domain for a first tenant in response to a first memory allocation request for a coherent memory domain associated with a first plurality of devices of the system and a first memory range; and
allocating a second memory domain for a second tenant in response to a second memory allocation request for a non-coherent memory domain associated with a second plurality of devices of the system and a second memory range, wherein the first memory domain is isolated from the second memory domain.

15. A system comprising:
a plurality of processors;
a plurality of accelerators;
a system memory to be dynamically partitioned into a plurality of memory domains including at least one coherent memory domain and at least one non-coherent memory domain; and
a switch to couple at least some of the plurality of processors and at least some of the plurality of accelerators via Compute Express Link (CXL) interconnects, the switch to dynamically create the at least one coherent memory domain in response to a first memory allocation request and dynamically create the at least one non-coherent memory domain in response to a second memory allocation request.

16. The system of claim 15, wherein the switch is to dynamically update the at least one coherent memory domain to be another non-coherent memory domain in response to a memory update request.

17. The system of claim 15, wherein the switch comprises a CXL switch, the CXL switch comprising a memory domain table having a plurality of entries, each of the plurality of entries to store memory region information, at least one of one or more process address identifiers or at least one of one or more tenant identifiers that belong to a memory domain, and one or more devices within the memory domain.

18. The system of claim 17, wherein at least some of the plurality of entries are to further store least one fallback rule for handling a memory request when an interconnect congestion level exceeds a threshold.

19. The system of claim 18, wherein the CXL switch further comprises a telemetry circuit to maintain telemetry information comprising the interconnect congestion level.

20. The system of claim 18, wherein the CXL switch is to receive the first memory allocation request comprising a memory range for the at least one coherent memory domain, a coherency indicator, one or more process address identifiers that belong to the at least one coherent memory domain, one or more devices within the at least one coherent memory domain, and at least one fallback rule for handling coherency for a memory request when a congestion level on one or more of the CXL interconnects exceeds a threshold.
